(19) United States
(12) Patent Application Publication
(10) Pub. No.: US 2024/0243516 A1
(43) Pub. Date: Jul. 18, 2024

(54) SEPARABLE ELECTRICAL CONNECTOR WITH A FLUID PORT

(71) Applicant: Cooper Power Systems, LLC, Waukesha, WI (US)

(72) Inventor: Jonathan Michael Schaar, New Berlin, WI (US)

(21) Appl. No.: 18/410,472

(22) Filed: Jan. 11, 2024

Related U.S. Application Data
(60) Provisional application No. 63/438,905, filed on Jan. 13, 2023.

(51) Int. Cl. H01R 13/53; H01R 13/648

(52) U.S. Cl. CPC H01R 13/53; H01R 13/648

(57) ABSTRACT

In one aspect, a separable electrical connector includes: an electrically conductive shield; an electrically conductive insert; and a housing between the electrically conductive shield and the electrically conductive insert, the housing including a first end and a second end, the second end including a recess, the recess including a surface configured to seal against a bushing. The separable electrical connector also includes an electrical conductor extending into the recess; and a fluid port configured to provide a fluid to the recess when the bushing is in the recess.

### CROSS-REFERENCE TO RELATED APPLICATION

This application claims the benefit of U.S. Provisional Application No. 63/438,905, filed on Jan. 13, 2023 and titled IMPROVED MEDIUM-VOLTAGE SEPARABLE CONNECTOR, which is incorporated herein by reference in its entirety.

### TECHNICAL FIELD

This disclosure relates to a separable electrical connector with a fluid port.

### BACKGROUND

An electrical connector is used to connect electrical transmission and distribution equipment and electrical sources within a power electrical system.

### SUMMARY

In one aspect, a separable electrical connector includes: an electrically conductive shield; an electrically conductive insert; and a housing between the electrically conductive shield and the electrically conductive insert, the housing including a first end and a second end, the second end including a recess, the recess including a surface configured to seal against a bushing. The separable electrical connector also includes an electrical conductor extending into the recess; and a fluid port configured to provide a fluid to the recess when the bushing is in the recess.

Implementations may include one or more of the following features.

The fluid port may be accessible from an exterior of the separable electrical connector.

The fluid port may include a passage that passes through the electrically conductive shield, the electrically conductive insert, and the housing.

The fluid port may include a passage that passes through the housing. An electrical field grading element may be in the passage. The electrical field grading element may include an impedance that is electrically connected to the electrically conductive insert and the electrically conductive shield. The electrical field grading element may be an electrically insulating body, and may include geometric features that increase the surface length of the element. The fluid port may include a valve coupled to a first end of the electrical field grading element. The valve may be accessible from the exterior of the electrical connector.

The separable electrical connector also may include a removable cap on the fluid port.

The fluid port may be configured to provide the fluid to the recess when the surface is sealed against the bushing.

The separable electrical connector also may include a fluid restricting device at the first end of the housing.

In another aspect, a method includes: providing a pressurized fluid to a recess of an electrical connector while a bushing is in the recess; and separating the electrical connector from the bushing after providing the pressurized fluid to the recess of the electrical connector.

Implementations may include one or more of the following features.

Providing the pressurized fluid to the recess of the electrical connector may include providing the pressurized fluid to the recess by directing the pressurized fluid through a fluid port on an exterior of the electrical connector while the bushing is in the recess.

Providing the pressurized fluid to the recess of the electrical connector while the bushing is in the recess may include providing the pressurized fluid through a fluid port on an exterior of the electrical connector while the bushing is sealed against a surface of the recess, and the pressurized fluid may break the seal between the surface of the recess and the bushing.

The pressurized fluid may have a greater dielectric strength than ambient air at standard atmospheric conditions.

In another aspect, a system includes: a separable electrical connector including an electrically insulating housing between an electrically conductive shield and an electrically conductive insert, the electrically insulating housing including a recess, the recess including a surface configured to seal against a bushing. The system also includes an electrical conductor extending into the recess; and a field grading element in a bore that that passes through the electrically insulating housing and the electrically conductive insert.

Implementations may include one or more of the following features.

The system also may include a fluid port on an exterior surface of the separable electrical connector, and the fluid port is in fluid communication with the bore and the recess.

The system also may include a fluid port on an exterior surface of the separable electrical connector, the bore may pass through the shield, and the fluid port may be in fluid communication with the bore and an interior region of the separable electrical connector.

The field grading element may include an impedance that is electrically connected to the electrically conductive insert and the electrically conductive shield.

Implementations of any of the techniques described herein may include a system, an assembly, an electrical connector, and/or a method. The details of one or more implementations are set forth in the accompanying drawings and the description below. Other features will be apparent from the description and drawings, and from the claims.

### DRAWING DESCRIPTION

FIG. 1A is a block diagram of an alternating-current (AC) electrical power distribution network that includes a power device and a separable electrical connector.

FIG. 1B is a side cross-sectional view of a connection interface of the separable electrical connector of FIG. 1A.

FIG. 1C is a partial side cross-sectional view of the separable electrical connector of FIG. 1A mechanically and electrically connected to a bushing.

FIG. 1D is a partial side cross-sectional view of the separable electrical connector of FIG. 1A mechanically connected to a bushing.

FIG. 2 is a side cross-sectional view of another electrical connector.

FIG. 3 is a side view of a field grading insert.

FIG. 4 is a partial cutaway perspective view of field grading component.

FIG. 5 is a side view of a field grading component positioned in the passage.

FIG. 6 is a side cross-sectional view of another electrical connector.

FIG. 7 is a side view of a collar for an electrical connector.

FIG. 8 is a side view of a blocking device for an electrical connector.

### DETAILED DESCRIPTION

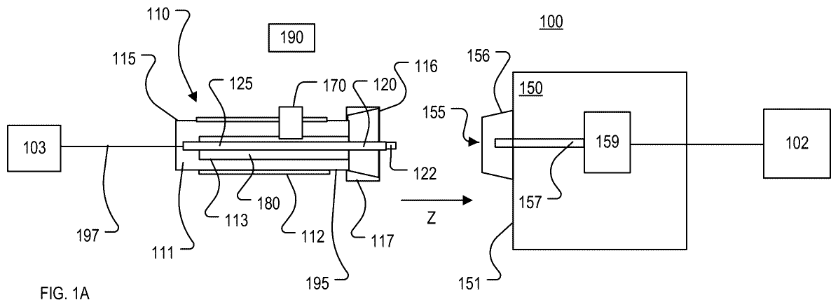

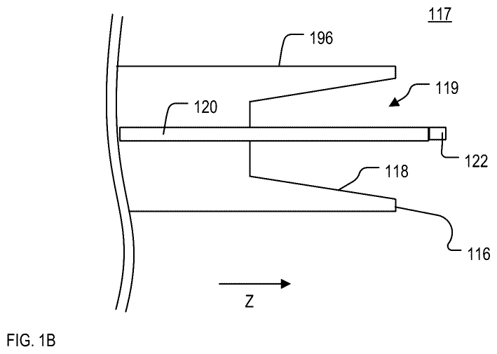

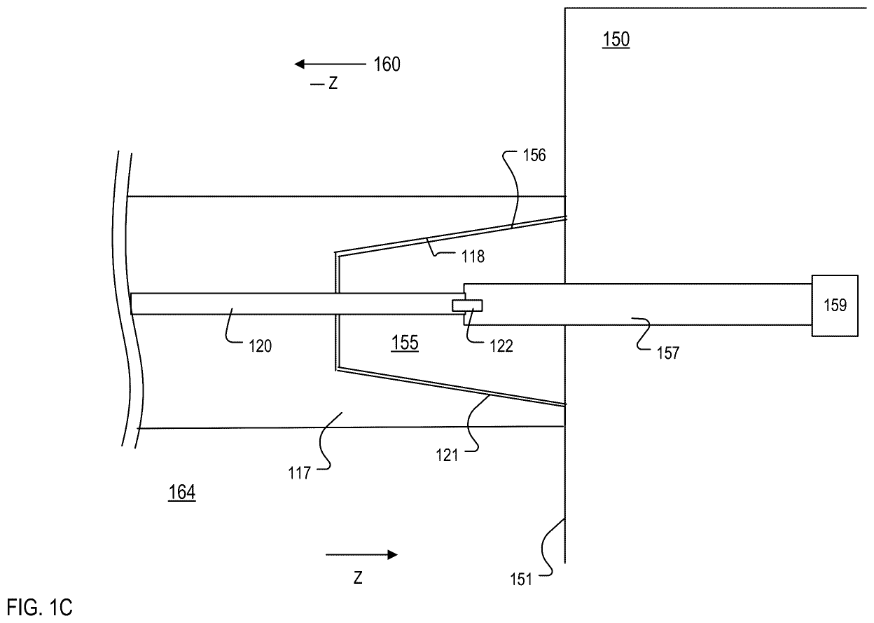

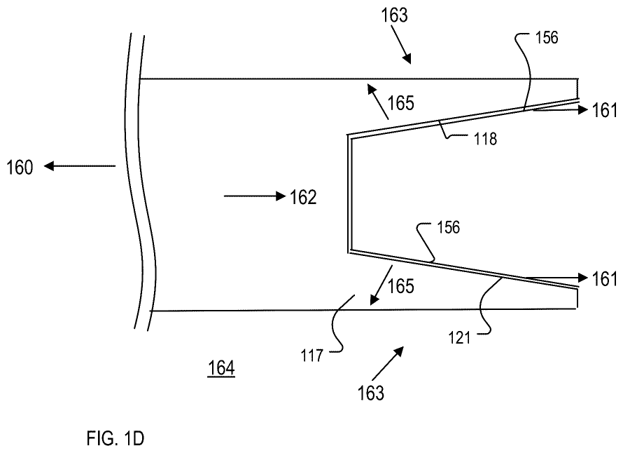

FIG. 1A is a block diagram of an alternating-current (AC) electrical power distribution network or electrical power system 100 that includes a power device 150 and a separable electrical connector 110. The electrical power system 100 may be, part of, for example, an electrical grid, an electrical system, or a multi-phase electrical network that provides electricity to industrial, commercial, and/or residential customers. The electrical grid may have an operating voltage of, for example, at least 1 kilovolt (kV), 12 kV, up to 34.5 kV, up to 38 kV, or 69 kV or higher, and may operate at a system frequency of, for example, 50 or 60 Hertz (Hz).

The separable electrical connector 110 is used to electrically connect an electrical cable 197 to the power device 150. The separable electrical connector 110 may be a medium voltage (for example, 15 kilovolts (kV) or 25 kV) electrical connector. The power device 150 may be a medium-voltage, dead-front utility apparatus, such as, for example, a transformer, voltage regulator, or switchgear. The power device 150 may be underground.

The separable electrical connector 110 includes a fluid port 170 that allows delivery of pressurized fluid 190 to an interior 180 of the electrical connector 110. As discussed below, the delivery of pressurized fluid to the interior 180 improves the safety, ergonomics, and usability of the electrical connector 110 as compared to an electrical connector that does not utilize pressurized fluid in an interior of the connector. For example, the delivered pressurized gas facilitates disconnection of the electrical connector 110 from the power device 150 and reduces the likelihood of flashover.

Before discussing various examples of the fluid port 170, an overview of the electrical connector 110 and the system 100 is provided.

The electrical connector 110 includes an electrically conductive shield 112, an electrically conductive insert 113, and an insulating housing 111 between the shield 112 and the insert 113. The electrically conductive shield 112 is on an outer surface 195 of the insulating housing 111. The shield 112 and the insert 113 may be semiconductive and may have a relatively low conductivity. For example, the shield 112 and the insert 113 may be a polymer or rubber that is doped with or otherwise includes an electrically conductive material. In some implementations, the shield 112 and the insert 113 are made with ethylene propylene diene monomer (EPDM) rubber that includes graphite, nickel, or another electrically conductive material. The insulating housing 111 is made of a material that is electrically insulating. The housing 111 may be made of, for example, EPDM or any rubber material, silicone, a polymer, a hardened or solidified foam, and/or hardened epoxy.

The electrically conductive shield 112 may be, for example, a coating, a jacket, or sheath. The electrically conductive shield 112 allows the outside of the electrical connector 110 to be connected to ground or a low voltage for safety. The electrically conductive shield 112 is not necessarily on the entire outer surface 195 of the housing 111, and some parts of the insulating housing 111 may form the exterior of the electrical connector 110.

The insert 113 surrounds a portion of a current path 125 that is in the interior 180 of the housing 111. The current path 125 is the intentional current path through the electrical connector 110. The current path 125 includes a conductor 120 and conductive element(s) attached to the conductor 120. The current path 125 is at a relatively high voltage and/or conducts large currents when the conductor 120 is energized and connected to the power device 150. For example, the current path 125 may conduct currents of 200 amperes (A) or greater at voltages of 25 kV. The insert 113 is electrically connected to the conductor 120. Although shown as a rectangular element, the insert 113 includes rounded edges and creates a smooth surface that evenly distributes electrical stress and electrical fields that arise within the insulating housing 111 during use of the electrical connector 110.

The electrical connector 110 extends from a first end 115 to a second end 116 and includes a connection interface 117 at the second end 116. Referring also to FIG. 1B, which is a side cross-sectional view of the connection interface 117, the connection interface 117 includes a recess 119 that is defined by a surface 118 of the insulating housing 111. The electrical conductor 120 extends into the recess 119. The connection interface 117 and the surface 118 are made of an electrically insulating material. The surface 118 is not rigid and has at least some flexibility or pliability. The surface 118 may be, for example, a rubber material.

An exterior 196 of the connection interface 117 may be rigid to provide structure to the interface 117 or may have some flexibility and pliability. In some implementations, the surface 118 includes a latching feature (for example, a detent or lip) that latches onto a corresponding feature on the wall 156 to further secure the bushing 155 in the recess 119. The recess 119 is three-dimensional. In the example shown, the surface 118 has a truncated cone or tapered cone shape.

FIG. 1C shows a partial side cross-sectional view of the separable electrical connector 110 mechanically and electrically connected to the bushing 155. The bushing 155 may be or may include a bushing insert. A bushing insert is inserted into a bushing as an intermediate component between the bushing and a cable connector (such as the electrical connector 110). The insert is easily replaceable if it is damaged during connection or separation. For simplicity, only the bushing 155 is shown.

The bushing 155 is a substantially rigid and electrically insulating three-dimensional object that extends from an exterior surface 151 of the power device 150. The bushing 155 has a truncated cone or tapered cone shape and an outer wall 156. The wall 156 surrounds a bushing conductor 157 that is electrically connected to the circuit 159.

The electrical connector 110 is attached to the bushing 155 by placing the surface 118 over the wall 156 and applying force to the electrical connector 110 in the Z direction. Applying force in this manner inserts the bushing 155 into the recess 119 and connects the conductor 120 to the bushing conductor 157. The bushing wall 156 and the surface 118 are similarly shaped, with the surface 118 being slightly larger than the wall 156 and/or flexible or pliable such that the bushing 155 fits in the recess 119, and the bushing wall 156 and the surface 118 are held together at an interface 121 with an interference fit.

Additionally, prior to placing the surface 118 over the wall 156, a sealing aid may be applied to the wall 156 and/or to the surface 118 of the recess 119. The sealing aid is any type of substance that is not electrically conductive and decreases friction between two joined objects. For example, the sealing aid may be a gel, grease, or oil that includes silicone. If used, the sealing aid forms an additional bond or seal at the interface 121 between the surface 118 and the wall 156 that is in addition to the friction fit between the surface 118 and the wall 156. The interference fit and/or seal at the interface 121 protects the conductors 120, 157 from fluid ingress and provides an additional dielectric barrier between the conductors 120, 157 and the shield 112.

The electrical connector 110 is a livebreak or loadbreak electrical connector that does not require that the conductors 120 and 157 be de-energized before separating the electrical connector 110 from the bushing 155. In other words, the current flowing through the conductors 120 and 157 may be interrupted by separating the electrical connector 110 from the bushing 155. The electrical connector 110 includes arc-quenching, ablative, or other materials capable of suppressing an electrical arc that can form when the conductors 120 and 157 separate while energized. In the example shown, an ablative tip 122 is mounted to the conductor 120. An arc that forms between the conductors 120 and 157 is drawn across the ablative tip 122 as the conductor 120 loses connection to the bushing conductor 157 during separation. The ablative materials in the tip 122 respond to the high temperatures in the arc by emitting gasses and/or other matter that suppresses and extinguishes the arc before the arc expands enough to fault to ground. Other implementations are possible. For example, the arc-suppressing material may be in the surface 118 and the electrical connector 110 may be implemented without the tip 122.

To remove the electrical connector 110 from the bushing 155, an operator applies a disconnection force 160 to the electrical connector 110. The disconnection force 160 is in a direction that is away from the power device surface 151. For example, the operator may pull on the electrical connector 110 in the −Z direction with their hand or with a hotstick.

Referring also to FIG. 1D, which shows various forces that may exist when the bushing wall 156 is in the recess 119, the magnitude of the disconnection force 160 sufficient to remove the electrical connector 110 from the bushing 155 depends on the magnitude of the forces that hold the bushing 155 in the recess 119. The forces that hold the bushing 155 in the recess 119 include frictional forces 161 between the surface 118 and the wall 156, a latching force 162 (in implementations that include a latching feature in the surface 118 and a corresponding feature in the wall 156), and a negative pressure force 163. The frictional forces 161 include friction between the surface 118 and the wall 156 and adhesion forces from the sealing aid (if used). Additionally, the sealing aid may harden over time into a glue-like substance that bonds the surface 118 to the wall 156, thereby increasing the force 161 over time.

The negative pressure force 163 is the difference between the pressure of fluid in the free space in the recess 119 and the pressure of the environment 164 external to the electrical connector 110. The environment 164 is not intentionally pressurized or depressurized, and the pressure of the air in the environment 164 is standard atmospheric pressure with small variations due to weather or altitude. Under static conditions, the pressure difference between the environment 164 and the recess 119 is negligible. During the dynamic process of pulling the electrical connector 110 off the bushing 155, the volume of open space in the recess 119 increases. However, the seal at the interface 121 between the surface 118 and the wall 156 blocks fluid flow, thereby reducing the pressure of the open space in the recess 119 relative to the pressure of the environment 164 and generating the negative pressure force 163 during the removal of the electrical connector 110 from the bushing 155. The negative pressure force 163 presses the surface 118 onto the wall 156 and holds the bushing 155 in the recess 119.

The forces 161, 162, 163 may be substantial compared to the disconnection force 160 that a human operator can easily apply. On the other hand, the electrical connector 110 includes the fluid port 170, which allows pressurized fluid 190 to enter the interior 180 of the electrical connector 110 and the recess 119 in an intentional manner. The pressurized fluid 190 generates a positive pressure force 165 that pushes the surface 118 and the wall 156 apart. For example, an operator of the electrical connector 110 or the system 100 may use the fluid port 170 to introduce the pressurized fluid 190 shortly before attempting to remove the electrical connector from the bushing 155. The pressurized fluid 190 generates the positive pressure force 165 in the space between the surface 118 and the wall 156 and/or in the interior 180 of the electrical connector 110. The positive pressure force 165 expands some or all of the surface 118 outward, breaking or weakening the adhesion of the surface 118 to the wall 156 and pushing the surface 118 and the wall 156 apart. Thus, the fluid port 170 and the pressurized fluid 190 facilitates the intentional disconnection of the electrical connector 110 from the bushing 155.

Furthermore, introducing the pressurized fluid 190 to the recess 119 also decreases the likelihood of flashover. As discussed above, when the electrical connector 110 is removed from the bushing 155, the surface 118 seals against the wall 156 and creates a vacuum or a relatively low pressure in the open region of the recess 119 (between the surface 118 and the wall 156) as the surface 118 is pulled from the wall 156. The lower pressure corresponds to a reduced dielectric strength and breakdown voltage of the open region in the recess 119. By introducing the pressurized fluid 190 to the open region of the recess 119, the pressure, dielectric strength, and breakdown voltage of the open region of the recess 119 also increases. Due to the increased pressure in the recess 119, an arc that forms during a loadbreak operation performed with the electrical connector 110 with the pressurized fluid 190 admitted to the recess 119 via the fluid port 170 is less likely to result in flashover.

Although any pressurized fluid may be used as the pressurized fluid 190, in some implementations, the fluid 190 includes nitrogen or other gasses for enhanced dielectric strength. Moreover, a liquid may be used as the pressurized fluid 190. Examples of liquids that may be used as the pressurized fluid 190 include, without limitation, a silicone-based liquid or a dielectric fluid. The fluid 190 is an electrically insulating fluid.

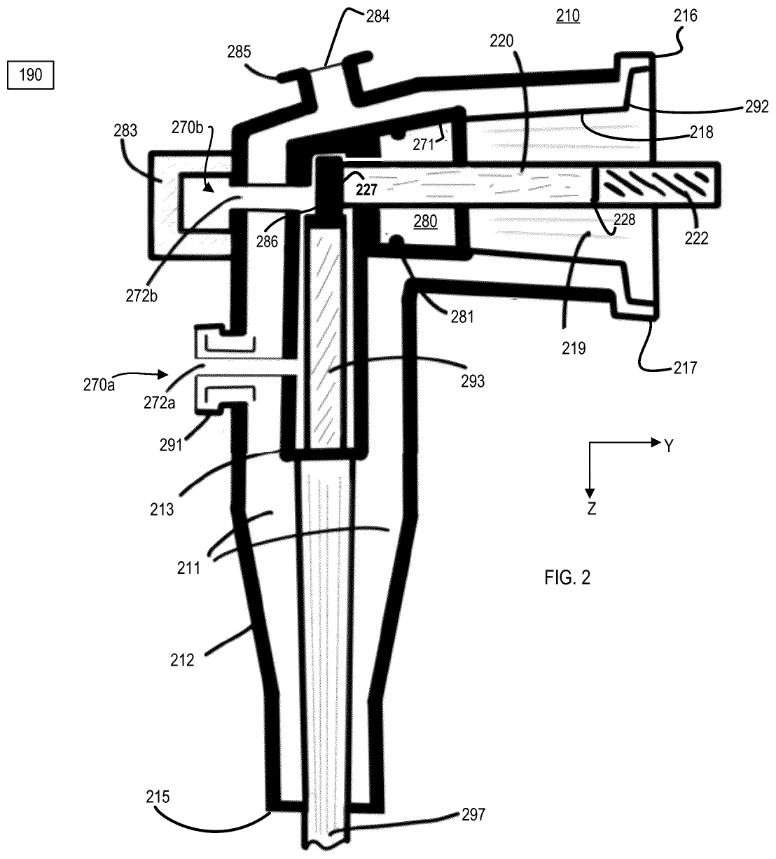

FIG. 2 is a side cross-sectional view of an electrical connector 210. The electrical connector 210 is a loadbreak or livebreak elbow connector that may be used to connect a cable 297 to the electrical circuit 159 in the power device 150 (FIG. 1A). The electrical connector 210 includes fluid ports 270a and 270b, each of which allow an operator to intentionally introduce the pressurized fluid 190 into an interior 280 of the electrical connector 210.

The electrical connector 210 includes an electrically conductive shield 212 and an electrically conductive insert 213. The shield 212 and the insert 213 are made of a semi-conductive material with a relatively low conductivity. For example, the shield 212 and the insert 213 may be made of a rubber or polymer that includes an electrically conductive material. In some implementations, the shield 212 and the insert 213 are made of a peroxide-cured EPDM rubber that includes graphite, nickel, or another electrically conductive material.

The shield 212 provides electrical shielding to conductive elements in the electrical connector 210 and also may be connected to ground. The insert 213 creates a smooth surface that evenly distributes electrical stress and electrical fields that arise within the electrical connector 110 during use. The insert 213 is illustrated as having some square or rectangular edges, but this is not necessarily the case. For example, the insert 213 may have some rounded edges or may have only rounded edges and surfaces.

An electrically insulating housing 211 is between the shield 212 and the insert 213, with the shield 212 being on an exterior of the insulating housing 211. The insulating housing 211 is any type of electrically insulating material that has some flexibility or pliability. For example, the insulating housing 211 may be a rubber (such as EPDM) or a polymer material. The insulating housing 211 extends from a first end 215 to a second end 216. The second end 216 includes a connection interface 217 that is open at a recess 219, which is defined by a surface 218. In the example of FIG. 2, the surface 218 is a portion of an inner side of the insulating housing 211. The recess 219 also includes a flared region 292, which is at the end 216, and a locking region 281. The side of the locking region 281 is surrounded by the insert 213 but the locking region 281 is open to the recess 219. In other words, the recess 219 (including the flared region 292 and the locking region 281) are a single open space and are shaped to engage with a bushing on a power device. The recess 219 is a three-dimensional space that also extends in the X direction (into and out of the page).

The electrical connector 210 also includes a conductor 220 that extends in the Z direction from a first end 227 to a second end 228. The first end 227 of the conductor 220 is attached to a conductive assembly 286, and the second end 228 is attached to or includes an ablative tip 222. The conductor 220 extends into the recess 219, and the ablative tip 222 extends beyond the recess 219. The ablative tip 222 is an arc follower that includes an ablative, arc-quenching or arc-extinguishing material. The conductor 220 also may be referred to as a loadbreak or livebreak probe.

The conductive assembly 286 is any electrically conductive junction that can hold the conductor 220 securely. For example, the conductive assembly 286 may be a metal block or cylinder that includes threads that connect to corresponding threads on the exterior of the end 227 of the conductor 220. The conductive assembly 286 may be made of, for example, copper, silver, gold, or a metal alloy.

The conductive assembly 286 is also attached to a cable connector 293. The cable connector 293 may be attached to the conductive assembly 286 by, for example, soldering or welding or by a mechanical fastener (for example, threads or a bolt). The other end of the cable connector 293 is crimped to the cable 297. The cable connector 293 may be, for example, a metal barrel or hollow cylinder that has threads at one end for connection to the conductive assembly 286 and that is open at the other end for crimping to the cable 297.

The conductor 220 extends from the conductive assembly 286 in the Z direction, and the cable connector 293 extends from the conductive assembly 286 in the Y direction. In other words, the conductor 220 and the cable connector 293 are substantially orthogonal to each other such that the electrical connector 210 has an elbow shape in the Y-Z plane. The conductor 220, the conductive assembly 286, the cable connector 293, and the cable 297 form an intentional current path through the electrical connector 210. When the connection interface 217 is attached to a bushing of a power device (such as the power device 150 of FIG. 1A), electrical current can flow from the power device to the cable 297 via the intentional current path.

The interior 280 includes open space. For example, there is open space between an inner side 271 of the insert 213 and the conductive assembly 286, between the inner side 271 of the insert 213 and the conductor 220, and/or between the inner side 271 of the insert 213 and the cable connector 293. The open space in the interior 280 is also in fluid communication with the recess 219. Although the conductor 220 is electrically connected to the insert 213, the insert 213 is not fluidly sealed to the conductor 220. For example, in some implementations, the insert 213 does not entirely conform to the conductor 220 or the conductive assembly 286. In these implementations, the fluid 190 is able to flow in spaces between the inner side 271 of the insert 213 and the outer surface of the conductive assembly 286 and the conductor 220, and into the recess 219. In some implementations, the insert 213 touches portions of the conductor 220 and/or the conductive assembly 286, but the insert 213 is not sealed or bonded to the conductor 220 or the conductive assembly 286. In these implementations, the pressurized fluid 190 is able to flow along a space between the inner side 271 of the insert 213 and at least a portion of the outer surface of the conductive assembly 286 and the conductor 220. Moreover, in some implementations, the insert 343 includes passageways or bores to provide a fluid connection between the recess 219 and the interior 280. In these implementations, the pressurized fluid 190 flows through the bores in the insert 213 and may or may not flow along the outer surface of the conductive assembly 286 and/or the conductor 220.

The electrical connector 210 also includes a fill port 285 and a test point 291 that are accessible from an exterior of the electrical connector 210. The fill port 285 is a cylindrically shaped port that is defined by the shield 212. The fill port 285 is open to the region between the shield 212 and the insert 213 and provides an access point to inject or pour the insulating housing 211 between the shield 212 and the insert 213 during manufacture or assembly of the electrical connector 210. In the electrical connector 210, the fill port 285 is plugged with the insulating housing 211 and is closed off from the exterior of the electrical connector 210. An electrically conductive cover 284 that is in contact with the shield 212 may be applied over the insulating plug and the fill port 285. The electrically conductive cover 284 may be, for example, a semiconductive paint or coating.

The test point 291 is a connection point where an operator may place a measurement device, such as a capacitive sensor. In a legacy electrical connector, the test point 291 is not in fluid communication with the interior 280 of the electrical connector. However, in the electrical connector 210, the test point 291 also acts as the fluid port 270a. The fluid port 270a extends outward from the electrical connector 210 and is accessible from the exterior of the electrical connector 210. The fluid port 270a may include a hose or tube connector that is capable of connecting to a fluid supply (such as a tank or canister that holds a pressurized gas). The fluid port 270a also may include metering devices that control the properties of the pressurized gas that flows into the port 270a. For example, the fluid port 270a may include or may be configured to attach to one or more valves, flowmeters, and/or pressure monitoring devices. Moreover, the fluid port 270a may be operated by a control system that sets various limits on the pressurized fluid 190 that enters the interior 280. For example, the fluid port 270a may be controlled and/or operated manually to ensure that a maximum pressure of the fluid 190, a maximum time for admitting the fluid 190 into the interior 280, and/or a maximum flow rate of the fluid 190 are not exceeded.

The fluid port 270a includes a bore or passage 272a that passes through the shield 212, the insulating housing 211, and the insert 213. The passage 272a fluidly connects the open space in the interior 280 with the fluid port 270a. The fluid port 270a may be used to provide the pressurized fluid 190 to the open space in the interior 280 via the passage 272a.

The electrical connector 210 also includes a second fluid port 270b. The second fluid port 270b includes a passage 272b that extends through the shield 212, the housing 211, and the insert 213. The passage 272b fluidly connects the port 270b to the open space in the interior 280. The port 270b is accessible from outside the electrical connector 210 and may be used to deliver the pressurized fluid 190 to the open space in the interior 280. The fluid port 270b is near an operator interface 283 that extends outward from the shield 212. The operator interface 283 is a rigid loop that can be connected to a hotstick or other tool to aid in disconnecting the electrical connector 210 from a bushing. Placing the fluid port 270b near the operator interface 283 may allow the operator to apply the disconnection force 160 and supply the pressurized fluid 190 to the open space in the interior 280 via the second fluid port 270b at the same time or in rapid succession.

Like the fluid port 270a, the fluid port 270b may include a hose or tube connector that is capable of connecting to a fluid supply (such as a tank or canister that holds a pressurized gas). The fluid port 270b also may include metering devices that control the properties of the pressurized gas that flows into the port 270b. For example, the fluid port 270b may include or may be configured to attach to one or more valves, flowmeters, and/or pressure monitoring devices. Additionally, the fluid port 270a and/or the fluid port 270b may include a removable cap or other cover to close off the respective passage 272a and 272b when the ports are not in use.

Other implementations are possible. For example, the electrical connector 210 may be implemented with only one of the fluid ports 270a, 270b. In some implementations, the electrical connector 210 includes the fluid port 270b and does not include the fluid port 270a or the test point 291. Furthermore, a fluid port may be in a location other than shown in FIG. 2. For example, the fluid port 270a may be implemented as an attachment to the fill port 285. In these implementations, the passage 272a passes through the insulating housing 211 and the insert 213 to the open space in the interior 280 but does not necessarily pass through the shield 212. In another example, a fluid port and passage may be placed in another part of the electrical connector 210 where there is not already a port or connection point.

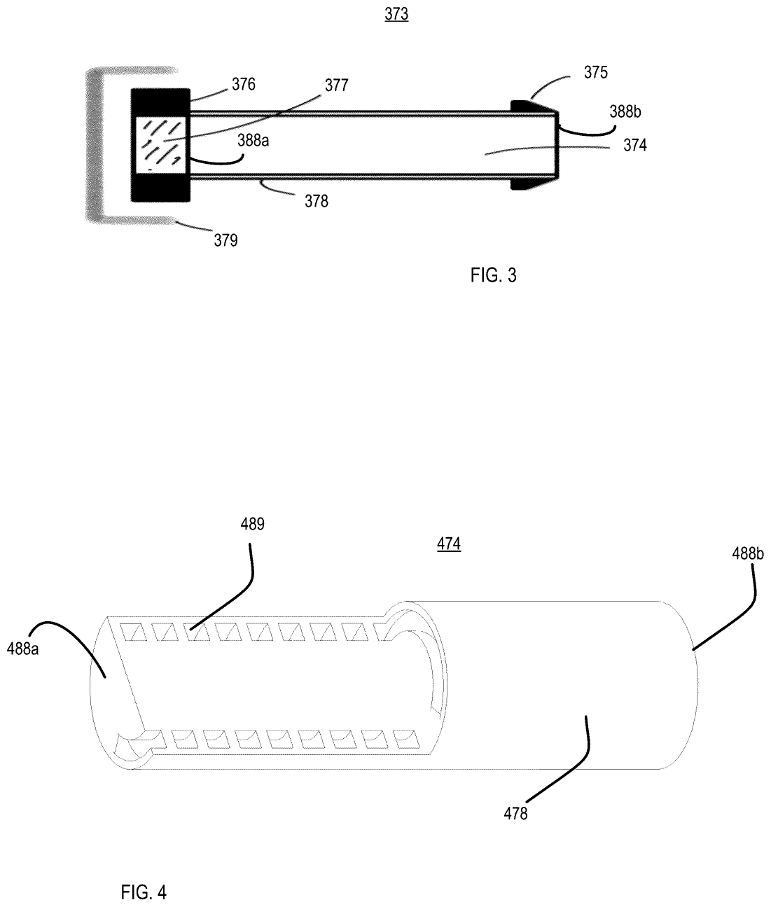

FIG. 3 is a side view of a field grading insert 373 that may be inserted into the passage 272a or 272b to ensure a gradual change in electrical potential from the insert 213 to the shield 212. The gradual change in potential results in a relatively uniform electric field between the insert 213 and the shield 212. Maintaining a relatively uniform field intensity between the insert 213 and the shield 212 reduces the chance of dielectric breakdown and arcing within the electrical connector 210. Although the field grading insert 373 improves the performance of the electrical connector 210, the electrical connector 210 may be used without the insert 373.

The field grading insert 373 includes a field grading component 374 that has an outer surface 378. The field grading component 374 extends from a first end 388a to a second end 388b. The field grading component 374 may be an impedance such as a resistor, capacitor, inductor, or a combination of such devices. In some implementations, the field grading component 374 is an electrically insulating cylinder that includes surface features (for example, sheds or spirals) that increase the electrical length of the field grading component.

The first end 388a is attached to a valve 377 and a fluid system mounting assembly 376, and the second end 388b has a retention assembly 375. The retention assembly 375 is configured to attach to the inner side 271 of the electrically conductive insert 213 (FIG. 2). In some implementations, the retention assembly 375 acts as a barb to fix the field grading insert 373 within the electrical connector 210. The outer diameter of the field grading insert 373 is larger than the diameter of each passage 272a, 272b. To install the field grading insert 373 in the passage 272a, the retention assembly 375 is inserted through the fluid port 270a and into the passage 272a. The shield 212, the housing 211, and the insert 213 flex as the field grading insert 373 in pushed into the passage 272a from the exterior of the electrical connector 210. Once the field grading insert 373 is fully inserted into the passage 272a, the retention assembly 375 attaches to the inner side 271 of the insert 213 to ensure a good connection with the insert 213. Other implementations are possible. For example, the field grading insert 373 may be bonded to the shield 212 and the insert 213 prior to the injection of the insulation material that forms the housing 211. In these implementations, the field grading insert 373 may lack the retention assembly 375.

The fluid system mounting assembly 376 is any type of device that allows the field grading insert 373 to fluidly connect to a fluid supply that holds the pressurized fluid 190. The fluid system mounting assembly 376 may be, for example, hose or tube attachment. The field grading insert 373 also includes a cap or cover 379. The cap 379 and the valve 377 help to prevent contaminants from entering the passage. The valve 377 also may be operated to control the flow of the pressurized fluid 190.

FIG. 4 is a partial cutaway perspective view of field grading component 474 that extends from a first end 488a to a second end 488b and includes an exterior surface 478. The field grading component 474 may be used in the field grading insert 373.

The field grading component 474 may be made of porcelain, thermoset polymer, thermoplastic polymer, glass, or any electrically insulating material. The field grading component 474 could alternatively be made of a highly resistive material such as metal oxide, or graphite infiltrated insulator. The field grading component 474 may utilize inductive or capacitive impedance to grade the electric field between the first end 488a and the second end 488b. For instance, the field grading component 474 may include many thin alternating layers of an electrical insulator and an electrical conductor to form a multiplate capacitor, or the field grading component 474 may include a very fine magnet wire with thousands of turns wound on an encapsulated core and having the start and end of the winding electrically connected to the insert and the shield of an electrical connector as an inductive shunt. For example, to use such a component 474 in the electrical connector 210 (FIG. 2), the start of the winding is electrically connected to the insert 213 and the end of the winding is electrically connected to the shield 212.

In the example shown in FIG. 4, a spiral structure 489 connects the first end 488a and the second end 488b. The spiral structure 489 is open or hollow and serves as a path for the pressurized fluid 190. The length of the spiral structure 489 is many times longer than the linear distance from the first end 488a to the second end 488b such that the spiral structure 489 also creates a long creep distance with high dielectric strength between the ends 488a and 488b. The spiral structure 489 may incorporate a resistive element to augment the field grading effect. When used with the electrical connector 210, the exterior surface 478 is sealed against the connector insulation 211 so a sufficient dielectric strength is developed from 488a to 488b to withstand transient voltage requirements.

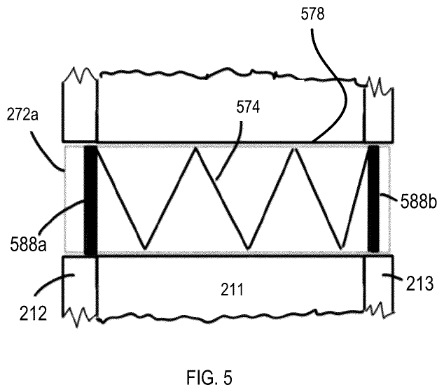

FIG. 5 is a side view of a field grading component 574 positioned in the passage 272a. The field grading component 574 is a resistor that has a first end 588a and a second end 588b. The field grading component 574 is enclosed in a tube 578. The first end 588a of the resistor is electrically connected to the shield 212 and the second end 588b of the resistor is electrically connected to the insert 213. By using a relatively high impedance resistor, for instance 10 Mega-Ohm or 10 Giga-Ohm, the field grading component 574 can provide a low-wattage circuit with a substantially uniform electric field.

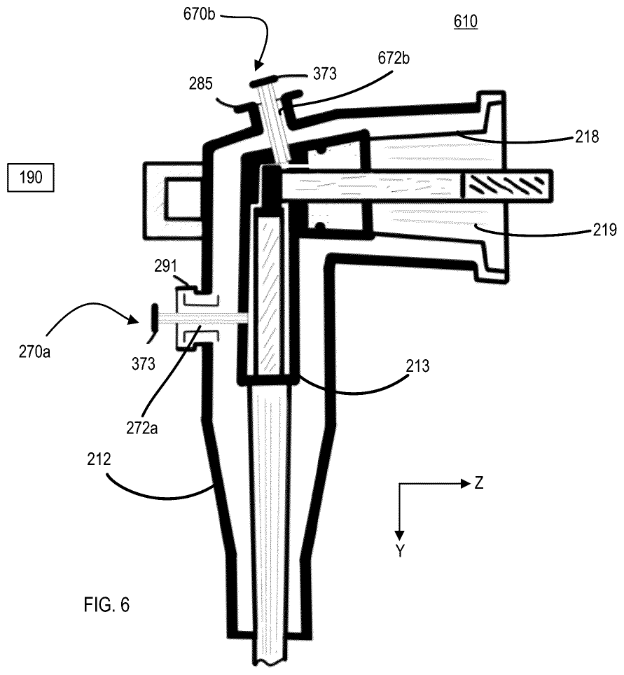

FIG. 6 is a side cross-sectional view of another electrical connector 610. The electrical connector 610 is the same as the electrical connector 210 (FIG. 2), except the electrical connector 610 includes a fluid port 670b instead of the fluid port 270b and the electrical connector includes two instances of the field grading insert 373. The fluid port 670b includes a passage 672b, which is an opening that passes through the housing 211 that is in the fill port 285 and through the insert 213 to the interior 280. The passage 672a may or may not pass through the shield 212.

The field grading insert 373 is inserted into the passage 672b. Another instance of the field grading insert 373 is inserted into the passage 272a. The field grading component 374 of each field grading insert 373 is in electrical connection with the shield 212 and the insert 213.

The passage 272a and the passage 672b may be part of the electrical connector 610 as originally manufactured, or either or both the passage 272a and the passage 672b may be added to the electrical connector after it is manufactured. In other words, the electrical connector 610 may be retrofit to include the passage 272a and/or the passage 672b.

To add a passage to the electrical connector 610, first a hole is drilled through one side of the electrical connector 610. For example, the passage 672b is formed by drilling a hole though the insulation in the fill port 285 and through the insert 213. If the field grading insert 373 is used, a lubricant may be applied to the outer surface 378 and then the end 388b is inserted into the passage 672b at the opening of the fill port 285. The lubricant and the compression of the insulating housing 211 forms a seal between the housing 211 and the outer surface 378. The fluid system mounting assembly 376 is positioned just outside the top of the fill port 285 and is accessible from the exterior of the electrical connector 610.

The addition of the passage 672b is provided as an example. Other passages may be added in a similar manner. For example, the electrical connector 210 may be retrofit to include the passage 272a and/or the passage 272b.

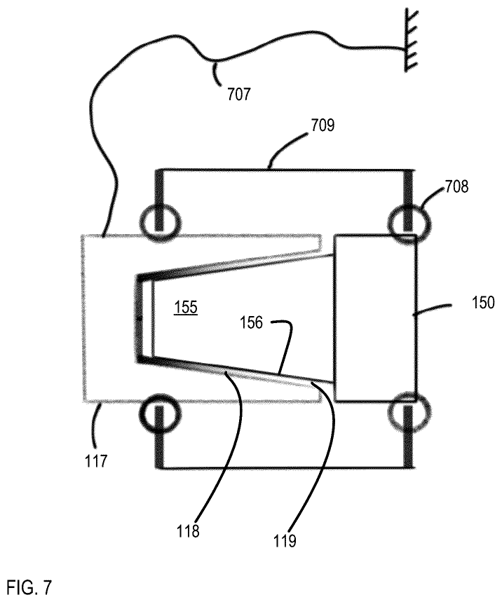

Additional details related to performing a loadbreak operation to disconnect the electrical connector 110 (FIG. 1A) from the bushing 155 is provided next with further reference to FIG. 7. To disconnect the electrical connector 110 from the bushing 155, the operator uses the fluid port 170 to deliver the pressurized fluid 190 to the open spaces in the interior 180. The pressurized fluid 190 also enters open space in the recess 119 while the bushing 155 is in the recess 119. The pressure in the recess 119 increases and the surface 118 expands outward, breaking the attachment between the surface 118 and the bushing wall 156.

In implementations in which the fluid 190 includes a liquid, little to no energy is stored as the pressurized fluid 190 enters the recess 119. In these implementations, after the attachment between the surface 118 and the bushing is broken, the pressure in the recess 119 drops rapidly to the pressure of the surrounding environment with minimal release of stored energy.

Compressed gas stores energy, and, in implementations in which the pressurized fluid 190 is a compressed gas, the gas may rush out of the recess 119 after the attachment between the surface 118 and the bushing wall 156 is breached. Referring to FIG. 7, which is a side view of the connector 110 and the bushing 155, a collar 709 may be placed around the electrical connector 110 and the bushing 155 to contain the fluid 190 after the seal between the surface 118 and the bushing wall 256 is broken. The collar 709 may be, for example, a ring or bracket that encircles the electrical connector 110. The collar 709 can include one or more seals 708 (only one of which is labeled) to improve the fit. If the compressed fluid 190 is gas, the collar 709 also may aid in maintaining the pressure in the recess 119 above atmospheric conditions after the seal between the surface 118 and the bushing wall 256 is broken. Maintaining the pressure in the recess 119 in this manner may improve the dielectric strength of the air in the recess 119 while the arc extinguishes, even if only for a brief moment. Whether with or without the use of a collar 709, a restraint 707 can be fixed to the electrical connector 110 to restrict the movement of the electrical connector 110 in the event of the connector 110 being forcefully propelled away from the bushing 155.

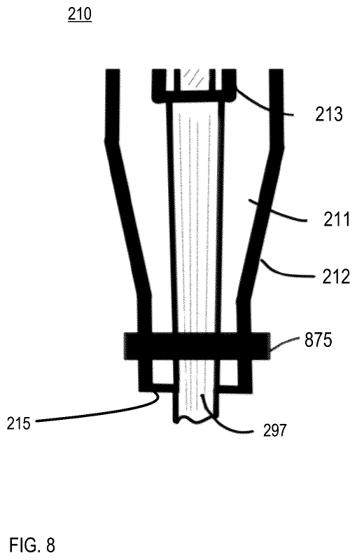

Referring also to FIG. 8, which is a partial view of the electrical connector 210, in some implementations, a fluid blocking device 875 may be placed around the electrical connector 210 near the first end 215 of the connector 210. Although the cable 297 is sealed to the electrical connector 210, without the fluid blocking device 875, some of the pressurized fluid 190 that is introduced through the port 270a and/or 270b may escape through the end 215. This could prevent adequate pressure from building in 219 to benefit removal. Placement of the fluid blocking device 875 prevents unintentional loss of the pressurized fluid from the interior 280. The fluid blocking device 875 is anything capable of reinforcing the seal between the end 215 and the cable 297. For example, the fluid blocking device 875 may be a zip-tie, a stainless steel band, a clamp, or a combination of such devices.

These and other implementations are within the scope of the claims. Moreover, other implementations are possible. For example, the electrical connector 210 and/or 610 may include additional features. For instance, in some implementations, the electrical connector 210 and/or 610 includes a non-linear impedance device, such as a metal oxide varistor (MOV), that is enclosed in the housing 211 and electrically connected to the cable 297. The electrical connector 210 and/or 610 are illustrated as elbow connectors, but the fluid ports 270a, 270b, and 670a may be used in electrical connectors of other shapes and configurations. For example, a fluid port may be installed in a C-shaped or U-shaped connector that includes more than one loadbreak probe.

What is claimed is:

1. A separable electrical connector comprising:
an electrically conductive shield;
an electrically conductive insert;
a housing between the electrically conductive shield and the electrically conductive insert, the housing comprising a first end and a second end, the second end comprising a recess, the recess comprising a surface configured to seal against a bushing;
an electrical conductor extending into the recess; and
a fluid port configured to provide a fluid to the recess when the bushing is in the recess.

2. The separable electrical connector of claim 1, wherein the fluid port is accessible from an exterior of the separable electrical connector.

3. The separable electrical connector of claim 1, wherein the fluid port comprises a passage that passes through the electrically conductive shield, the electrically conductive insert, and the housing.

4. The separable electrical connector of claim 1, wherein the fluid port comprises a passage that passes through the housing.

5. The separable electrical connector of claim 4, wherein the fluid port comprises an electrical field grading element in the passage.

6. The separable electrical connector of claim 5, wherein the electrical field grading element comprises an impedance that is electrically connected to the electrically conductive insert and the electrically conductive shield.

7. The separable electrical connector of claim 5, wherein the electrical field grading element is an electrically insulating body comprising geometric features that increase the surface length of the element.

8. The separable electrical connector of claim 5, wherein the fluid port comprises a valve coupled to a first end of the electrical field grading element.

9. The separable electrical connector of claim 8, wherein the valve is accessible from the exterior of the electrical connector.

10. The separable electrical connector of claim 1, further comprising a removable cap on the fluid port.

11. The separable electrical connector of claim 1, wherein the fluid port is configured to provide the fluid to the recess when the surface is sealed against the bushing.

12. The separable electrical connector of claim 1, further comprising a fluid restricting device at the first end of the housing.

13. A method comprising:
providing a pressurized fluid to a recess of an electrical connector while a bushing is in the recess; and
separating the electrical connector from the bushing after providing the pressurized fluid to the recess of the electrical connector.

14. The method of claim 13, wherein providing the pressurized fluid to the recess of the electrical connector comprises providing the pressurized fluid to the recess by directing the pressurized fluid through a fluid port on an exterior of the electrical connector while the bushing is in the recess.

15. The method of claim 13, wherein providing the pressurized fluid to the recess of the electrical connector while the bushing is in the recess comprises providing the pressurized fluid through a fluid port on an exterior of the electrical connector while the bushing is sealed against a surface of the recess, and the pressurized fluid breaks the seal between the surface of the recess and the bushing.

16. The method of claim 13, wherein the pressurized fluid has a greater dielectric strength than ambient air at standard atmospheric conditions.

17. A system comprising:
a separable electrical connector comprising:
an electrically insulating housing between an electrically conductive shield and an electrically conductive insert, the electrically insulating housing comprising a recess, the recess comprising a surface configured to seal against a bushing; and
an electrical conductor extending into the recess; and
a field grading element in a bore that that passes through the electrically insulating housing and the electrically conductive insert.

18. The system of claim 17, further comprising a fluid port on an exterior surface of the separable electrical connector, wherein the fluid port is in fluid communication with the bore and the recess.

19. The system of claim 17, further comprising a fluid port on an exterior surface of the separable electrical connector, wherein the bore passes through the shield, and the fluid port is in fluid communication with the bore and an interior region of the separable electrical connector.

20. The system of claim 17, wherein the field grading element comprises an impedance that is electrically connected to the electrically conductive insert and the electrically conductive shield.
